(19) United States
(12) Patent Application Publication
(10) Pub. No.: US 2007/0038530 A1
(43) Pub. Date: Feb. 15, 2007

(54) Gemstone certificate production and delivery system

(76) Inventors: Randall M. Wagner, Mequon, WI (US); Glenn A. Cassens, Mequon, WI (US); Kurt P. Schoeckert, Hartford, WI (US); Ben L. Wong, Mequon, WI (US)

Correspondence Address: COOK & FRANKE S.C., 660 East Mason Street, Milwaukee, WI, 53202, US

(21) Appl. No.: 11/585,772

(22) Filed: Oct. 23, 2006

Related U.S. Application Data
(63) Continuation-in-part of application No. 11/333,006, filed on Jan. 17, 2006.
(63) Continuation-in-part of application No. 11/512,005, filed on Aug. 28, 2006.
(60) Provisional application No. 60/645,982, filed on Jan. 21, 2005.
(60) Provisional application No. 60/711,982, filed on Aug. 26, 2005.
(60) Provisional application No. 60/729,125, filed on Oct. 21, 2005.
(60) Provisional application No. 60/831,072, filed on Jul. 14, 2006.

(51) Int. Cl. G06Q 30/00

(52) U.S. Cl. 705/26

(57) ABSTRACT

This invention is a method for delivering, viewing and printing an electronic gemstone certificate to a remote computer or PC via the internet. When the gemstone, diamond or jewelry piece reaches the final retail store, a unique identification number is entered into interactive report viewer software, and the corresponding electronic versions of the reports are electronically downloaded to the PC and its viewer software. The electronic report includes data and images from lab reports, light performance reports, or a combination thereof. The PC can print paper facsimiles of the electronic report for use in the retail sale of the piece, or the PC can order a high quality, formal printed report for delivery to the retail outlet or the end consumer. The formal printed report can include all or a portion of the data and images for one or both the lab and light performance reports, or the combined report.

This is a Continuation-In-Part of U.S. patent application Ser. No. 11/333,006 filed Jan. 17, 2006 for a Method and System for Online Evaluation of Gemstones, which asserts priority on U.S. Provisional Application No. 60/645,982 filed Jan. 21, 2005, and is a Continuation-In-Part of U.S. patent application Ser. No. 11/512,005 filed Aug. 28, 2006 for a Personalized Gemstone Certificate Card, which seeks priority on U.S. Provisional Application No. 60/711,982 filed Aug. 26, 2005, and further seeks priority on U.S. Provisional Application No. 60/729,125 filed Oct. 21, 2005 and U.S. Provisional Application No. 60/831,072 filed Jul. 14, 2006.

### BACKGROUND OF THE INVENTION

### Technical Field of the Invention

This invention relates to an internet based method of producing and delivering a gemstone or jewelry certificate that eliminates the need for printed certificate to travel with gemstone or jewelry piece through a conventional distribution and delivery system.

Most diamond and jewelry pieces of significant value come with a conventional lab report or certificate similar to that shown in FIG. 1. These documents 20 are purchased from various diamond and jewelry grading labs both domestically and internationally, and accompany the diamond or jewelry piece to the consumer for insurance and verification purposes. These certificates 20 are printed copies of data and images collected by the diamond laboratory upon physical inspection of the diamond or jewelry piece. Certificates 20 vary in size and format, and rang from credit card sized reports to full size, multi-page documents on 8.5×11 inch sheets or larger.

A diamond or jewelry manufacturer typically submits a diamond or jewelry piece to a grading lab 14 to be evaluated and graded. Many hundreds of diamonds or jewelry pieces are often submitted at once. Upon completing the examination of a particular jewelry piece, the lab prints a certificate for that piece, and returns the piece along with its corresponding certificate to the manufacturer that submitted the piece. However, the certificate 20 is frequently not returned to the manufacturer at the same time as the diamond or jewelry piece. This separation of the diamond or jewelry piece from its certificate 20 results in a significant sorting and matching operation at the manufacturer facility. Moreover, even when the certificate 20 is returned with its jewelry piece, there is often an additional report that must be sorted and matched. Manufacturers commonly receive shipments of 100 to 1,000 jewelry pieces that must be matched with 100 to 1,000 corresponding certificates 20.

Once these jewelry pieces and corresponding certificates 20 are matched, the manufacturer ships them to the retail jeweler's home office. The retailer must then inventory the pieces, and send them and their corresponding reports 20 to its individual retail stores. Over time and as inventory is moved around, the reports 20 often become lost or misplaced, and the retailer must order replacement reports. In addition, the reports 20 are usually larger than the jewelry pieces, which causes storage problems throughout the various steps in the distribution process. The cumbersome nature of this conventional report storage and delivery system results in thousands of wasted man-hours throughout the distribution process.

The jewelry industry also produces light performance reports to help evaluate and identify diamond and jewelry pieces. The patented Brilliance scope instrument disclosed in U.S. Pat. No. 5,615,005 collects data and corresponding images for diamonds and gem stones to produce such a report 30 as shown in FIG. 2. The data 32 and corresponding images 34 for a particular diamond or gem are printed on the report 30. The Brilliance scope instruments are used worldwide to obtain the data 32 and images34 that are electronically transmitted to and collected at a central processing facility via the internet. Upon approval that the data 32 and images 34 are valid, the facility produce a printed document 30 called a light performance report 30. The report 30 accompanies the lab report 20 with the diamond through various steps of the distribution process. The data 22 and images 24 from the certificate 20 generated by the diamond lab for individual diamonds are also frequently sent to the central processing facility for incorporation into the light performance report 30. The two reports 20 and 30 can be combined to generate a printed combined report 40 as shown in FIG. 3. The combined report 40 includes data 42 and images containing all or a portion of the data 22 and 32 and images 24 and 34 of the grading lab reports 20 and Brilliance scope instrument reports 30.

As above, retailers must inventory pieces, and send them with their corresponding reports 20, 30 or 40 to its individual retail stores. Over time and as inventory is moved around, the reports 20, 30 and 40 often become lost or misplaced, and the retailer must order replacement reports. The size of the reports 20, 30 or 40 cause storage problems throughout the various steps in the distribution process.

The present invention is intended to solve these and other problems.

### BRIEF DESCRIPTION OF THE INVENTION

The invention relates to a process that allows a person to view a gemstone certificate via a remote personal computer (PC) connected to the internet, and an internet based electronic delivery system that eliminates the need for printed certificates to travel with gemstones or jewelry through the distribution and delivery system. Each gemstone, diamond or jewelry piece has its own unique identification number. When the piece reaches the final retail store, the identification number is entered into interactive report viewer software, and the corresponding electronic versions of the reports are electronically downloaded to the PC and its viewer software. The electronic reports are then electronically viewable at a moments notice on the computer screen of the PC. The interactive report includes data and images from lab and light performance reports. Upon demand, a person can use the PC to print paper facsimiles of the electronic report for use in the retail sale of the piece. The person can also use the PC to order a high quality, formal printed report for delivery to the retail outlet or the end consumer. The formal printed report can include all or a portion of the data and images for one or both the lab and light performance reports, or the combined report.

The report production and delivery system is designed to deliver an individual report to any mail address entered into a database of the system. Upon the sale of the jewelry piece, the sales agent of the store can enter the address of the customer into the report production and delivery system, and the desired report will be produced and delivered to the specified address within days. Alternately, in the event that the jewelry retail outlet desires to deliver the report with the sale of the jewelry piece, the report can be ordered and delivered to the retail outlet, which still eliminates the need to deliver, match and track the report documentation throughout much of the manufacturing and distribution network.

Presently, diamond laboratories are not equipped to deliver reports to any entity other than the entity that delivered the jewelry for grading. The subject report production and delivery system advances the conventional report production and delivery system for the diamond and jewelry industry. The subject report production and delivery system will save thousands of man-hours for both the manufacturers and the retailers.

Other aspects and advantages of the invention will become apparent upon making reference to the specification, claims and drawings.

### BRIEF DESCRIPTION OF THE DRAWINGS

FIG. 1 shows a conventional lab report for a diamond.

FIG. 2 is a conventional light performance report produced by a BrilliantScope light performance measurement and capture instrument.

FIG. 3 is a combined report produced by a combination of data and images from a conventional lab report and a conventional light performance report.

FIG. 4 is a flow chart showing the flow of information to a central facility that generates an electronic or e-certificate for displaying on a PC or for printing at a print station.

FIG. 5 is a flow chart showing the steps in the interactive report viewer software.

### DESCRIPTION OF THE PREFERRED EMBODIMENTS

While this invention is susceptible of embodiment in many different forms, the drawings show and the specification describes in detail a preferred embodiment of the invention. It should be understood that the drawings and specification are to be considered an exemplification of the principles of the invention. They are not intended to limit the broad aspects of the invention to the embodiment illustrated.

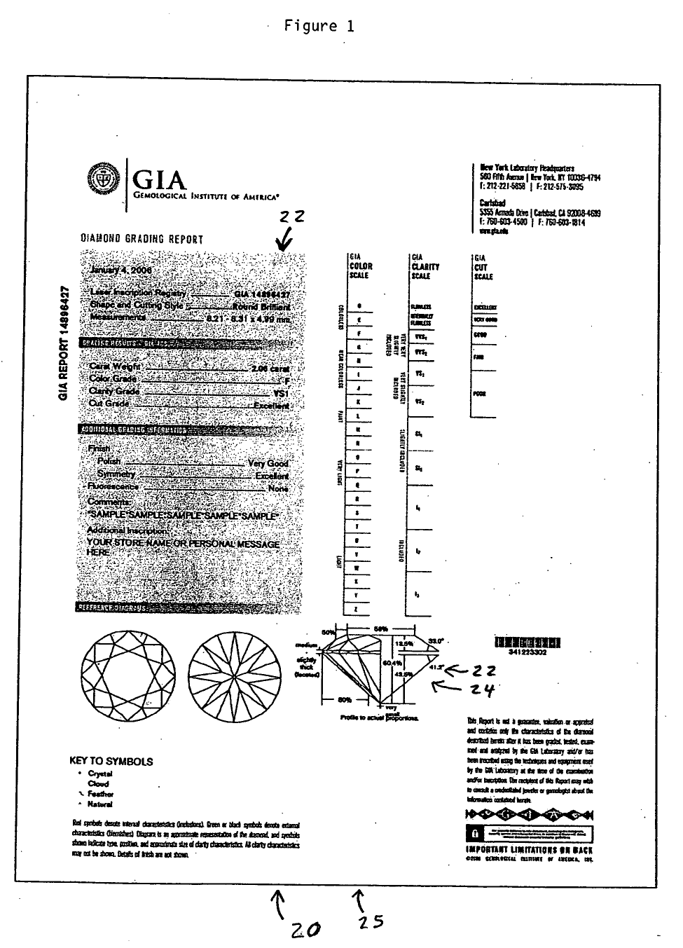

Gemstone, diamond and jewelry pieces 5 produced by a manufacturer 12 are typically sent to a grading lab 14 before being sent through their distribution channel. The distribution channel typically includes a distributor or wholesaler 15 that forwards the piece to a retail store 18, and is ultimately purchased by an end consumer 18. The gemstone, diamond and jewelry pieces 5 of significant value typically come with a lab report or certificate 20 produced by the grading lab 14. A conventional certificate 20 is shown in FIG. 1. The certificates 20 are purchased from various diamond and jewelry grading labs 14 both domestically and internationally, and accompany the diamond 5 to the consumer 18 for insurance and verification purposes. The certificates 20 are printed copies of data 22 and images 24 collected by the diamond laboratory 14 upon physical inspection of the diamond or jewelry piece 5.

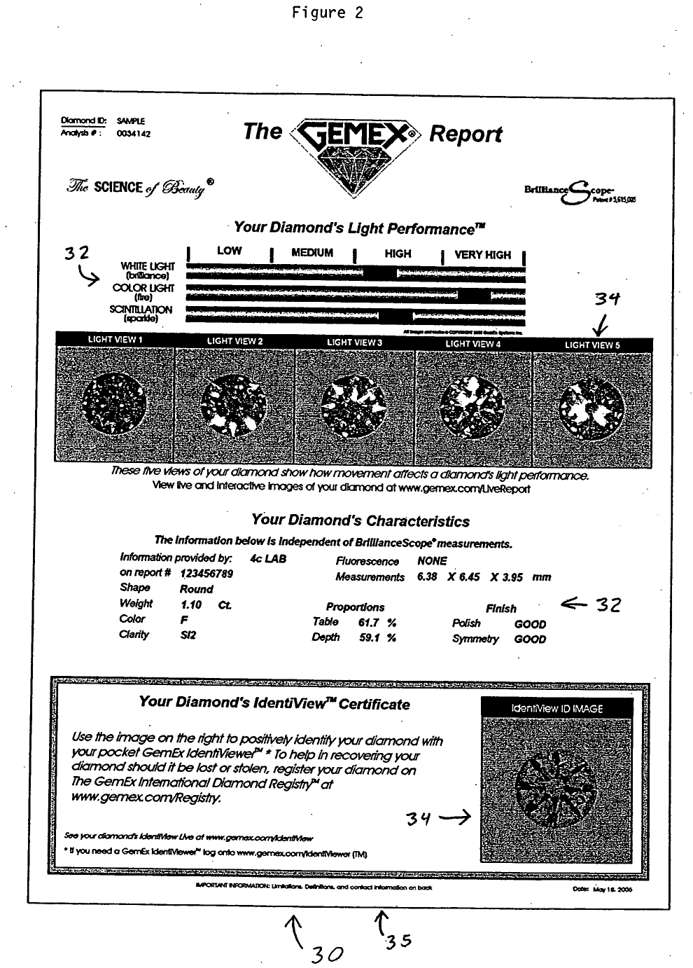

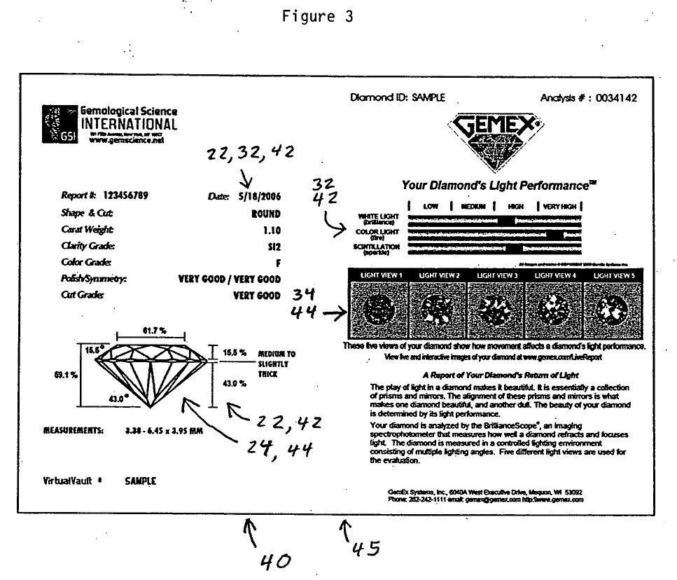

The jewelry industry also produces light performance reports 30 to help evaluate and identify diamond and jewelry pieces 5 as shown in FIG. 2. The data and images in report 30 are produced by a light performance instruments 31, such as the Brilliance scope® light performance instrument made by the GemEx company of Milwaukee, Wisconsin. Each report 30 includes data 32 and images 34 for a particular gemstone 5. The light performance instruments 31 obtain data 32 and images34 from various gemstone or jewelry pieces 5, with the data and images being electronically transmitted to and collected at a central processing facility via the internet. The report 30 accompanies the lab report 20 with the diamond through various steps of the distribution process 15, 16 and 18. The data 22 and images 24 from the certificate 20 generated by the diamond lab for individual diamonds are also frequently sent to the central processing facility for incorporation into the light performance report 30. The two reports 20 and 30 are combined to generate a printed combined report 40 as shown in FIG. 3. The combined report 40 includes data 42 and images containing all or a portion of the data 22 and 32 and images 24 and 34 of the grading lab and light performance reports 20 and 30.

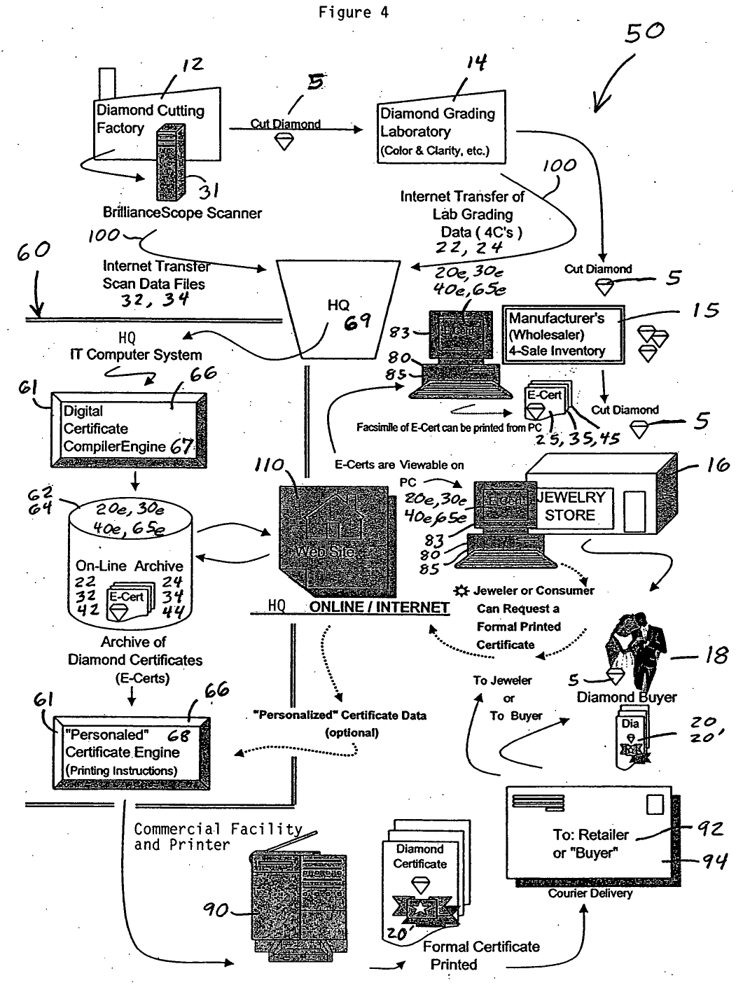

This invention pertains to the report production and delivery system generally shown in FIG. 4 as reference number 50. The report production and delivery system 50 includes a central or home office computer 60 with a processor and an associated memory 62 for storing the database 64. The system 50 produces electronic files 65e that contain the data 22, 32 and 42 and images 24, 34 and 44 of diamond or jewelry pieces 5 that are transferred to a commercial printing facility with a commercial grade printing device 90. Each file 65 contains the data 22, 32 and 42 and images 24, 34 and 44 for a particular diamond or jewelry piece 5. Each diamond or jewelry piece 5 has its own unique identification number. By entering this number, the commercial printing facility and commercial grade printing device 90 produces one or more unique reports 20′, 30 or 40 that are preferably laminated, customized, printed, documents with the desired data 22, 32 and 42 and images 24, 34 and 44 corresponding to each individual diamond 5 otherwise known as the diamond report or certificate 20′, 30 or 40. The standard certificate 20 is denoted as 20′ given that this report is not produced at the gemstone grading lab 14. Included in each electronic file 65e is a bar code that includes the delivery address for each individual document 20′, 30 or 40. Upon completion of printing, the commercial printing facility 90 scans the bar code on the report 20′, 30 or 40. An individual shipping label 92 is automatically produced for that report. The printing facility 90 uses the address label 92 on the envelope 94 for each individual report 20′, 30 or 40. The report 20′, 30 or 40 is delivered using any of various means, such as via US Mail, UPS or Federal Express carriers.

Retailers 16 have their own PCs 80 with a processor, keyboard and screen 83. The computer 80 is loaded with viewer software 85 that runs on a common computing platform such as Windows, Linux, or Apple operating systems. The viewer software 85 can be resident on the computer 80 or accessed remotely using a standard web-browser via the internet 100 at a designated website 110. The viewer software 85 also operates on, or is remotely accessible through the website 110 on, similar computer based systems that includes a monitor, local storage and are connectable to the internet 100, such as conventional cellular telephones and PDAs. The viewer software 85 is also downloadable to and loaded on the computer 80 of the manufacturer 12, lab 14, distributor or wholesaler 15, or buyer 18. In this regard, the term remote computer or PC 80 should be understood to include devices such as PDAs or cellular telephones containing a processor, memory, a data entry device such as a keyboard, and a viewing screen such as a monitor.

The PC 80 used with the viewer software 85 connects via the internet 100 to the Diamond Report database 64 associated with the central computer system 60. Upon request, (i.e., such as when a jewelry piece 5 is bar code scanned by the retailer 16 using the viewer software 85), the electronic file 65 of the report 20, 30 or 40 is downloaded into the computer, PC, PDA or cellular telephone 80 running the viewer software 85 for later viewing. The electronic files 65e of the documents 20e, 30e and 40e and their corresponding data 22, 32, 42 and images 24, 34, 44 are locally stored for immediate retrieval and display via the computer screen 83.

The homeoffice 69 maintains the associated database 64 of electronic files 65e that include the data 22, 32, 42 and images 24, 34, 44 of the diamond reports 20, 30 and 40 entered into the system 50. This database 64 is available to hardware or software systems that have been granted access to the database system 50, such as via a PC 80 loaded with the viewer software 85 or accessible to the PC via a web browser. Internet 100 access provides data 22, 32, 42 and images 24, 34, 44 for remote viewers 80 with software 85 to access the reports 20e, 30e or 40e upon demand. The data 22, 32, 42 and images 24, 34, 44 for all reports 20e, 30e or 40e for all diamonds 5, are permanently stored in this database 64 for retrieval at any time in the future.

When the piece 5 reaches the final retail store 16, the identification number is entered into the interactive report viewer software 85, and the corresponding electronic versions of the reports 20e, 30e or 40e are electronically downloaded to the PC or viewer 80 and its viewer software 85. The electronic reports 20e and 30e are then electronically viewable at a moments notice on a computer screen 83 of the PC 80. Upon demand, printed facsimiles 25, 35 and 45 of the electronic reports 20e, 30e and 40e can be printed out for use in the retail sale of the piece 5. Also, upon demand a high quality, formal printed report 20, 30 and 40 can be ordered for delivery to the retail outlet 16 or the end consumer 18. The formal printed report 20, 30 or 40 can include all or a portion of the data 22, 32 or 42 and images 24, 34 or 44 for one or both the Lab and light performance reports 20e and 30e, or the combined report 40e.

When the final printed documentation or diamond report 20′, 30 or 40 is desired, the manufacturer 12, lab 14, wholesaler 15, retailer 16 or customer 18 enters a “Report Delivery” request into the report viewer 80 running the viewer software 85. The individual 12-18 also inputs the shipping address and the unique identification number for the particular jewelry or diamond 5 into the viewer 80 and software 85, plus personalized data to include in reports 30 or 40. The Report Delivery request process includes report billing and shipping options using common internet shopping cart technologies that include web enabled credit card payment options. This initiates a report request that is transmitted via the internet 100 to the central computer 60 of a headquarters 69. When the central computer 60 receives the Report Delivery request, the computer 60 and software 66 including its Digital Certificate Compiler Engine 67 produces the electronic file 65e containing the desired report 20e, 30e or 40e for the particular piece 5. The software 66 also includes a Personalizing Certificate Engine 68 that is discussed in parent application Ser. No. 11/512,005, the disclosure of which is incorporated by reference. This personalizing engine 68 converts the electronic file 65e to a personalized electronic file. The software 66 electronically transmits the file 65e or the personalized version of the file to the commercial printing facility 90 for production and delivery of the commercial grade printed certificate 20′, 30 or 40 to the desired manufacturer 12, lab 14, wholesaler 15, retailer 16 or customer 18. These organizations or people 12-18 use a designated website 110 as a porthole to connect to the database 64. By entering the identification number for a particular diamond or gem 5, the data 22, 32, 42 and images 24, 34, 44 for that particular diamond or gem are downloaded to their computer 80, and the software 80 is executed to generate the electronic reports 20e, 30e or 40e for that particular diamond or gem.

The report production and delivery system 50 delivers an individual report 20, 20′, 30 or 40 to any mail address entered into a database 64 of the system 50. Upon the sale of the jewelry piece 5, the sales agent of the store 16 can enter the address of the customer 18 into the report delivery system 50 and the desired report 20, 20′, 30 or 40 will be produced and delivered to the specified address within days. Alternately, in the event that the jewelry retail outlet 16 desires to deliver the report 20, 20′, 30 or 40 with the sale of the jewelry piece 5, the report can be ordered and delivered to the retail outlet 16, which still eliminates the need to deliver, match and track the report documentation 20, 30 or 40 throughout much or the manufacturing and distribution network.

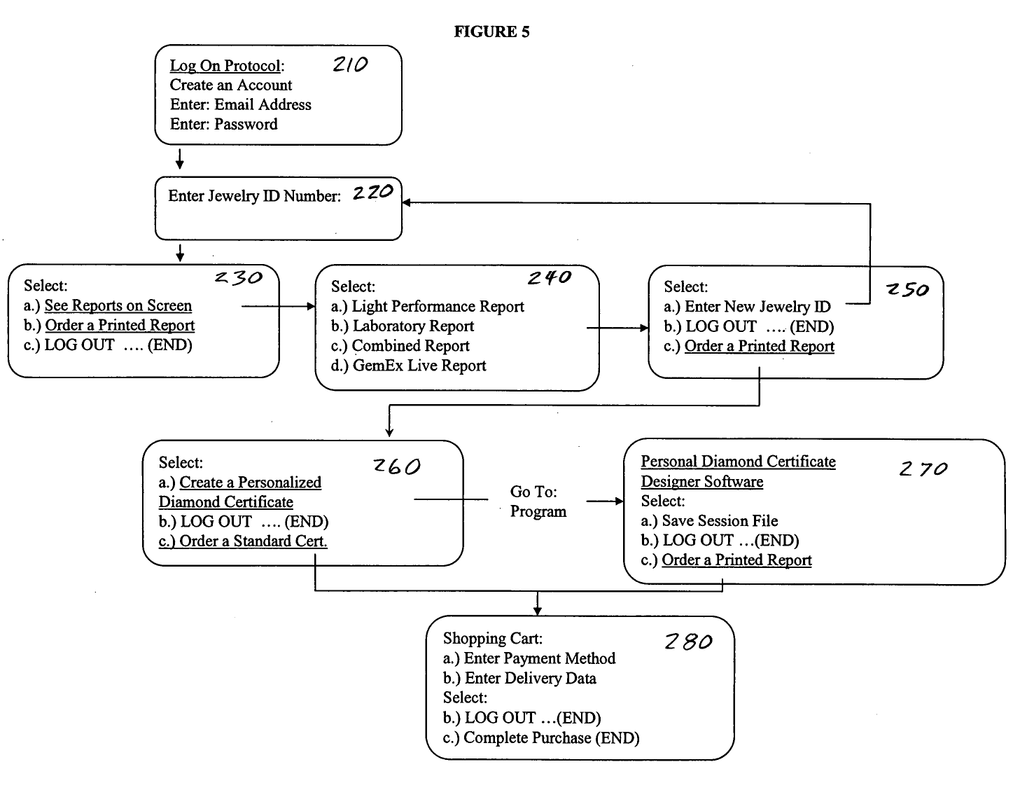

Although the process of performing the report production and delivery system 50 should be apparent from the above, FIG. 5 and the following is provided to assist the reader understand one embodiment of the process. An employee of a retail store 16 or customer 18 accesses the system website 110 using a remote computer 80 connected to the internet 100. If no prior account has been created, the graphic user interface (GUI) or screens for the website 110 first instructs employee 16 or person 18 to create an account with the system 50. A screen 210 is provided to enter the store or his or her email address and their associated password. Once the account of the store or person 16 or 18 is created, a screen 220 is provided requesting the unique identification number for a specific desired diamond, gemstone or jewelry piece 5.

Once the employee or person 16 or 18 enters the identification number for the specific desired piece 5, a screen 230 is provided requesting if they what to view an electronic report 20e, 30e or 40e on their computer screen 83, or if they want to order a printed report 20, 30 or 40. A screen 240 is then displayed asking the employee or person 16 or 18 to select the specific electronic report 20, 20e, 30, 30e, 40 or 40e he or she wants to view or print.

When an electronic report 20e, 30e, or 40e is requested, the digital certificate compiler engine 67 generates the desired electronic file 65e. It should be noted that the electronic files 65e for each of the plurality of gemstones 5 could be automatically generated by the compiler engine 67 as soon as the necessary data and images 22, 24, 32, 34, 42, 44 are received by the system 50, in advance of the request by the employee or customer 16 or 18. With respect to the electronic reports 20e, 30e and 40e, the system 50 allows the employee or person 16 or 18 to view an interactive gemstone certificate or “Live Report” as discussed in parent application Ser. No. 11/333,006, the disclosure of which is incorporated by reference. The software 66 then transmits the electronic file 65e to the remote computer 80 for remote viewing by the employee or person 16 or 18 on their monitor or screen 83.

When the employee or person 16 or 18 is finished viewing an electronic report 20e, 30e, or 40e for one specifically desired diamond, gemstone or jewelry piece 5, a screen 250 appear asking if the employee or person 16 or 18 would like to enter the identification number for an additional piece 5. If so, the system 50 returns to screen 230. An employee or person can continue viewing electronic reports 20e, 30e, 40e or Live Reports for a variety of diamond, gemstone or jewelry pieces 5.

When a paper report 20, 30, or 40 is requested, such as after a customer 18 has decided to purchase a specific desired piece 5, a screen 260 appears asking the employee or person 16 or 18 if they would like to print a standard report 20, 30 or 40 or personalize the standard report. If they would like to personalize the standard report 20, 30 or 40, the software 66 initiates the personalized certificate engine 68 to allow them to personalize the report as discussed in parent application Ser. No. 11/512,005. At the end of the personalization engine 68, a screen 270 appears asking them if they want to save or order the personalized report they have generated. Once a standard report 20, 30 or 40 is requested as in 260, or a complete personalized version of the standard report is requested as in 270, an order screen 280 appears for placing the order for the report for the specifically desired diamond, gemstone or jewelry certificate. As noted above, conventional software is available for taking the specific report order.

While the invention has been described with reference to a preferred embodiment, it will be understood by those skilled in the art that various changes may be made and equivalents may be substituted without departing from the broader aspects of the invention.

We claim:

1. A method of producing an electronic gemstone certificate for viewing by a person via a remote computer having a monitor, data entry device and memory, the remote computer being connected to the internet, said method of producing an electronic gemstone certificate comprising the steps of:
providing a central computer having a processor, an associated memory with a gemstone database, software including a digital certificate compiling engine, and an associated website with a graphic user interface, said website controllable connecting said central computer to the internet;
gathering electronic gemstone certificate data and identification numbers for a plurality of gemstones, each specific gemstone having a unique identification number and associated certificate data sufficient to generate a gemstone certificate for that specific gemstone;
transmitting said electronic gemstone certificate data and identification numbers for said plurality of said gemstones to said memory of central computer;
remotely accessing said website via the remote computer connected to the internet;
using the data entry device of the remote computer to enter an identification number for a specific desired gemstone via said graphic user interface of said website;
generating an electronic file for the specific desired gemstone via said digital certificate compiling engine, said electronic file containing said electronic gemstone certificate data sufficient to generate an electronic gemstone certificate for the specific desired gemstone;
transmitting said electronic file for the specific desired gemstone to the remote computer; and,
displaying said electronic gemstone certificate of the specific desired gemstone on the monitor of the remote computer.

2. The method of producing an electronic gemstone certificate of claim 1, and wherein the electronic gemstone certificate is viewable via the remote computer at any point along the distribution channel of the specific desired gemstone.

3. The method of producing an electronic gemstone certificate of claim 2, and wherein the remote computer has an associated printer, and further comprising the step of printing a printed facsimile of the electronic certificate via the associated printer of the remote computer.

4. The method of producing an electronic gemstone certificate of claim 2, and further comprising the step of using the remote computer to instruct said central computer to initiate manufacture of a formal printed gemstone certificate from a commercial printing facility.

5. The method of producing an electronic gemstone certificate of claim 4, and further comprising the step of having said central computer transmit said electronic file for the specific desired gemstone to a commercial printing facility computer with an associated commercial grade printing device, and having said commercial printing facility computer instruct its said commercial grade printing device to print said formal printed gemstone certificate.

6. The method of producing an electronic gemstone certificate of claim 4, and further comprising the step of having the remote computer settle payment with said central computer for said formal printed gemstone certificate prior to said central computer initiating manufacture of said formal printed gemstone certificate.

7. The method of producing an electronic gemstone certificate of claim 4, and further comprising the step of having the remote computer instruct said central computer to mail said formal printed gemstone certificate to a specific address designated by the person using remote computer.

8. The method of producing an electronic gemstone certificate of claim 1, and wherein said gathering step includes gathering gemstone certificate images for said plurality of gemstones, said transmitting step includes transmitting said gemstone certificate images to said memory of central computer, and said electronic file for the specific desired gemstone containing said gemstone certificate images for the specific desired gemstone.

9. The method of producing an electronic gemstone certificate of claim 1, and wherein said gathering step includes gathering gemstone certificate data and images, and further comprising the step of converting said gemstone certificate data and images to electronic gemstone certificate data and images.

10. The method of producing an electronic gemstone certificate of claim 1, and further comprising the steps of:
gathering light performance data and images for the plurality of gemstones;
converting said light performance data and images to electronic light performance data and images;
matching said electronic light performance data and images with said electronic certificate data and images for each said gemstone;
transmitting said electronic light performance data and images with said electronic certificate data and images for said plurality of said gemstones to said memory of central computer;
generating a combined electronic file for said specific desired gemstone via said digital certificate compiling engine, said combined electronic file containing electronic gemstone certificate and light performance data and images; and
displaying said electronic gemstone certificate and light performance data and images of the specific desired gemstone on the monitor of the remote computer.

11. The method of producing an electronic gemstone certificate of claim 10, and wherein said light performance data and images are gathered by a light performance measurement and capture instrument.

12. The method of producing an electronic gemstone certificate of claim 1, and wherein said gemstone data includes color, cut, clarity, carrot weight data for each of said gemstones.

13. The method of producing an electronic gemstone certificate of claim 8, and wherein said gemstone images include conventional photograph images for each of said gemstones.

14. The method of producing an electronic gemstone certificate of claim 1, and further comprising the step of having said central computer download viewer software to the remote computer prior to the displaying step.

15. The method of producing an electronic gemstone certificate of claim 1, and wherein said software of said central computer includes a personalized certificate engine allowing the person using the remote computer to personalize said electronic file for the specific desired gemstone via the remote computer.

16. The method of producing an electronic gemstone certificate of claim 1, and wherein said software of said central computer includes software for generating an interactive gemstone certificate.

17. The method of producing an electronic gemstone certificate of claim 1, and wherein said central computer allows the remote computer access to a desired electronic gemstone file via said website by entering said unique identification number.

18. The method of producing an electronic gemstone certificate of claim 1, and wherein said central computer saves said electronic gemstone data and images and identification numbers for the plurality of gemstones into an electronic database, said electronic database including separate gemstone data and images for each specific gemstone.

19. The method of producing an electronic gemstone certificate of claim 1, and wherein said digital certificate compiling engine automatically generates a plurality of electronic files for each of the plurality of gemstones upon receipt of said electronic certificate data and identification numbers for said plurality of said gemstones by said memory of central computer, and each of said electronic files is identified by said unique identification number and electronic gemstone data for its associated specific gemstone.

20. A method of producing an electronic gemstone light performance report for viewing by a person via a remote computer having a monitor, data entry device and memory, the remote computer being connected to the internet, said method of producing an electronic gemstone light performance report comprising the steps of:
providing a central computer having a processor, an associated memory with a gemstone database, software including a digital certificate compiling engine, and an associated website with a graphic user interface, said website controllable connecting said central computer to the internet;
gathering electronic gemstone light performance data and identification numbers for a plurality of gemstones, each specific gemstone having a unique identification number and associated certificate data sufficient to generate a gemstone light performance report for that specific gemstone;
transmitting said electronic gemstone light performance data and identification numbers for said plurality of said gemstones to said memory of central computer;
remotely accessing said website via the remote computer connected to the internet;
using the data entry device of the remote computer to enter an identification number for a specific desired gemstone via said graphic user interface of said website;
generating an electronic file for the specific desired gemstone via said digital certificate compiling engine, said electronic file containing said electronic gemstone light performance data sufficient to generate an electronic gemstone light performance report for the specific desired gemstone;
transmitting said electronic file for the specific desired gemstone to the remote computer; and,
displaying said electronic gemstone light performance report of the specific desired gemstone on the monitor of the remote computer.

21. The method of producing an electronic gemstone light performance report of claim 20, and wherein the electronic gemstone light performance report is viewable via the remote computer at any point along the distribution channel of the specific desired gemstone.

22. The method of producing an electronic gemstone light performance report of claim 21, and wherein the remote computer has an associated printer, and further comprising the step of printing a printed facsimile of the electronic light performance report via the associated printer of the remote computer.

23. The method of producing an electronic gemstone light performance report of claim 21, and further comprising the step of using the remote computer to instruct said central computer to initiate manufacture of a formal printed gemstone light performance report from a commercial printing facility.
